(19) United States
(12) Patent Application Publication
(10) Pub. No.: US 2014/0131427 A1
(43) Pub. Date: May 15, 2014

(54) DOCUMENT HOLDING DEVICE

(71) Applicants: William Mitchell SCOTT, Villa Hills, KY (US); James Gerard Lee, Westlake, OH (US)

(72) Inventors: William Mitchell SCOTT, Villa Hills, KY (US); James Gerard Lee, Westlake, OH (US)

(21) Appl. No.: 13/673,246

(22) Filed: Nov. 9, 2012

(51) Int. Cl. B42F 7/08

(52) U.S. Cl. CPC B42F 7/08
USPC 229/67.3

(57) ABSTRACT

A document holding device having a plurality of partitions, each partition having a front panel and rear panel joined at their top edges, and the rear panel of a partition being joined to the front panel of an adjacent partition along their bottom edges through a bottom spacer panel, and a brace for fixing the position of the plurality of partition panels in an assembled zigzag pattern. The device can provide a stable, free-standing document partition and holder for desktop use or for document boxes and file drawers.

### FIELD OF THE INVENTION

The present invention relates to partitions for separating and holding documents and files on desktops and within document box and file drawers.

### BACKGROUND OF THE INVENTION

Individuals and businesses across many industries use containers to store documents, materials, personal items, memorabilia, and the like. A common container for such use is a box having a lid, typically made of a corrugated paperboard or cardboard. Such file boxes are used in the hundreds of millions to hold and store any and all sorts of items that can fit within them.

A typical document storage box has opposed sidewalls in rectangular form of about 12 inches wide and 15 inches long, by about 11 inches high. Often, users want to store groups of documents stored in the storage box on their long edges, so that one or more, or a group or groups, of documents can be withdrawn laterally though the top opening of the file box.

One means of holding and grouping documents on edge in a file container is a hanging file folder. Hanging file folders, for use in storage units such as file cabinets, desk drawers, and the like (“office storage furniture”), are commonly found in modern offices and businesses. A hanging expandable file provides a plurality of partitions with closed sides, as described in U.S. Pat. No. 5,025,979 (Dellacroce), the disclosure of which is incorporated by reference in its entirety.

When such hanging file folders are stored in document storage boxes, the ends of the bars typically extend laterally beyond and over the top edge of the opposed sidewalls of the document box. The extending ends of the bars interfere with the placement of the container lid over the top edges of the file container.

It is common for users to become frustrated using manila file folders inside hanging files. One source of this frustration is that a very common US manila file folder size has a tab that is about 9.5 inches from central fold to the top of the tab, which is about the same depth as a very common US hanging file folder. Consequently, the tabs are largely or entirely within the file folder, and text on the tab cannot be read without either opening the hanging file folder or sliding the manila folder out far enough to read the tab. Current hanging folders also use metal hanging frames that are not intuitively portable or recyclable.

If manila folders are sized taller to extend over the top of hanging file folders, they are bent and folded each time the lid is positioned closed over the container box. Before long, the tabs of such manila folders are folded over or even detached from the folder, rendering them useless.

### SUMMARY OF THE INVENTION

The present invention provides a partition blank including a plurality of partition panels joined contiguously at opposite end edges along fold lines, for assembly of the blank into a document holding device that includes a plurality of partitions arranged in a zigzag pattern. The partition panels are joined with flexible hinges at the opposite end edges for assembly into the zigzag pattern.

An aspect of the invention is the use of the document holding device in a stable, free-standing configuration for furniture-top use. Another aspect of the invention is the use of the one or more of the document holding devices placed within a document box or interior space of a drawer of office storage furniture to partition the interior space of the document box or drawer into pockets.

The present invention also provides a document holding device that includes a plurality of front panels and a plurality of rear panels, each front panel and each rear panel having a top edge and a bottom edge, wherein the plurality of front panels are hingedly joined to an adjacent rear panel along a portion of their respective top edges, and at least one of the plurality of rear panels is hingedly joined to an adjacent front panel along a portion of their respective bottom edges.

The present invention further provides a brace for fixing the plurality of partition panels in position in an assembled zigzag pattern.

As an aspect of the invention, the side edges of any one partition panel are not attached to the respective side edges of an adjacent panel, or to any other structure.

In another aspect of the invention, a bottom edge of a front panel and bottom edge of a rear panel are joined indirectly, typically through a bottom spacer panel that has a forward edge joined to the bottom edge of the front panel, and a rearward edge joined to the bottom edge of the rear panel. The bottom spacer panel expands the bottom space of the pocket formed between the front panel and the rear panel.

In yet another aspect of the invention, the top edges of a front panel and a rear panel of a partition can be joined indirectly, typically through a top spacer panel that has a forward hingedly edge joined to the top edge of the front panel, and a rearward edge hingedly joined to the top edge of the rear panel.

In another aspect of the invention, the front panel includes a label tab portion that extends beyond the joined portion of its top edge. In a further aspect of the invention, the label tab portion is a separated portion from the adjacent rear panel contiguous with the front panel.

In another aspect of the invention, a brace of material has a first end that is attached to a bottom edge of a first partition panel, and extends under at least one adjacent partition panel to an adjacent, or more remote, partition panel. The brace has a second end that attaches to the bottom edge of the remote partition panel to prevent front to back movement of the bottom edges of the partition panels.

In yet another aspect of the invention, a brace of material has a first end that is attached to a bottom portion of a first partition, and a second end that attaches to the bottom portion of an adjacent second partition, or an even more remote partition, to prevent front to back movement of the bottom edges of the partitions.

In one aspect of the invention, the first end of the brace is integral with the material at, or proximate to, the bottom edge of a partition panel, typically hinged to a partition panel.

In another aspect of the invention, a tabbed end or other intermediate portion of the elongated body of the brace is inserted into a slot disposed in, or proximate to, a bottom edge of the partition panel. In yet another aspect of the invention, the tabbed end or elongated body portion of the brace has a means for improving the attachment of the tabbed end within the slot.

In another aspect of the invention, an attaching end of the brace can be unattached, allowing the folded partition panels to be disassembled and flattened, for ease of storage and transport, and then re-assembled at a different time or place.

In a further aspect of the invention, the brace of material is an elongated vertical portion of a partition panel. The brace material can be partially or wholly removable from the material of the partition panel. A partially removable brace can have an integrally attached end proximate the bottom edge of said partition panel, and lateral sides and a distal end that are separable from said partition panel.

In another aspect of the invention, the brace can be a removable portion along a lateral edge of a blank, and can be a single brace material or a brace material that can be further separated into two or more braces. In one aspect of such invention, the ends of the braces can be inserted into a slot in, or proximate to, the bottom edge of partition panels.

In another aspect of such invention, the brace material can be affixed along the bottom portions of the partition panels at either or both of the side edges of the respective partition panels.

A further aspect of the invention is a shape of the partition panels other than rectangular, including shapes with side and top edges that are trapezoidal or arched.

In another aspect of the invention, the construction material of the plurality of partition panels is paperboard, corrugate, plasticized corrugate, metal, plastic sheeting, and laminates and composites of any the foregoing and other material suitable for use for forming a container for use as such. Persons of skill in the art are well versed in suitable material types, and the embodiments herein are limited in their material usage.

In another aspect of the invention, any one or more of the plurality of partition panels can have a plurality of openings of any shape formed by removing portions of the material of the partition panel. This can reduce the weight of the partition panels and the document holding device without sacrificing structural integrity.

In another aspect of the invention, two or more document holding device can be assembled in series. The document holding device can include means associated with the forward end and/or rearward end of a document holding device, for fastening or associating the front end of a first document holding device with the opposite end of a second document holding device, to link the two document holding device in series.

In a further aspect of the invention, while the device is particularly useful for holding documents and files, the holding device is also useful as a holding device for a wide variety of other articles. Non-limiting examples of such other articles include poster boards, panes of glass; panels of construction materials, x-ray films, and large print photos. Although the description emphasizes holding devices for files and documents, useful within a document box of file drawer, the size and scale of other holding devices for such additional uses, including up to several feet (or meter(s)) are within the scope and teaching of the present description and figures.

### BRIEF DESCRIPTION OF THE FIGURES

FIG. 1 shows a corrugated blank that can be folded into a document holding device.

FIG. 2 shows a perspective view of a pre-folded partition device formed from the folded blank.

FIG. 3 shows a sectional view of the pre-folded partition device through line 3-3 of FIG. 2.

FIG. 4 shows a bottom perspective view as the pre-folded partition device is assembled into the document holding device using braces.

FIG. 5 shows the bottom perspective view of the document holding device assembled with braces.

FIG. 6 shows a front perspective view of the assembled document holding device of FIG. 5.

FIG. 7 shows a side view of the assembled document holding device as viewed along line 7-7 of FIG. 6.

FIG. 8 shows a corrugated blank that can be folded into a document holding device, using another brace embodiment.

FIG. 9 shows a bottom perspective view of the assembly of the document holding device using the other brace embodiment.

FIG. 10 shows the bottom perspective view of the assembled document holding device using the other brace embodiment.

FIG. 11 shows an assembled document holding device in position within a document box.

FIG. 12 shows a pair of assembled document holding device fastened together within a document box.

FIG. 13 shows a pair of assembled document holding device within a file drawer.

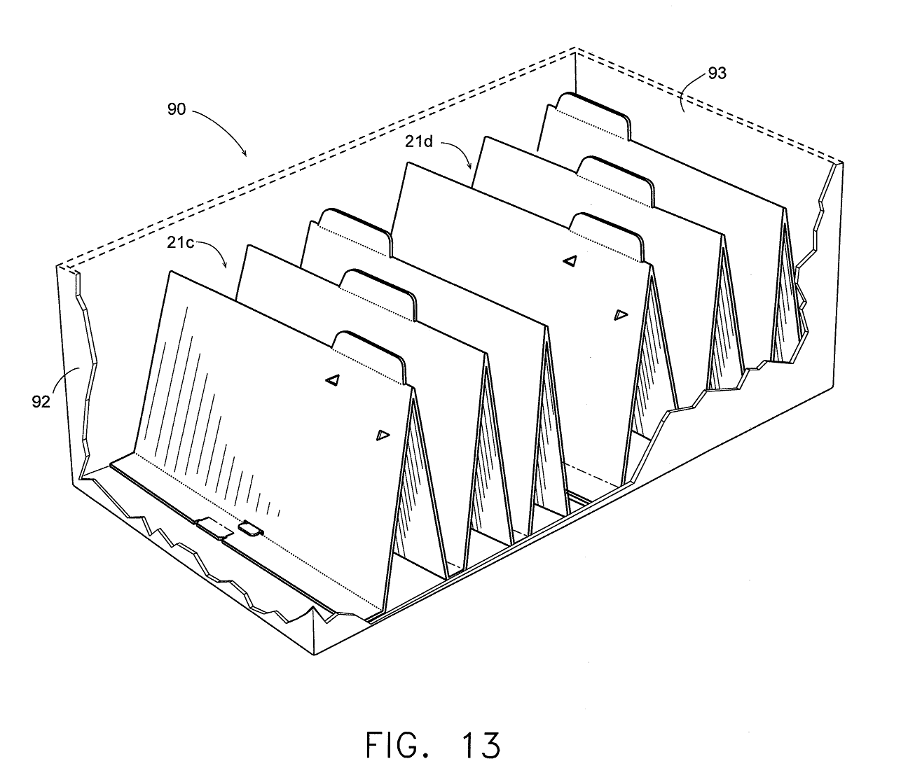

FIG. 14 shows an alternative corrugated blank having braces that are wholly separable from a partition panel of the blank.

FIG. 15 shows an assembled document holding device using the wholly separated braces of FIG. 14.

FIG. 16 shows another alternative corrugated blank having braces that are wholly separable from an end edge of the blank.

FIG. 17 shows another alternative corrugated blank having a single brace that is wholly separable from an end edge of the blank.

FIG. 18 shows an assembled document holding device using the wholly separated single brace of FIG. 14.

FIG. 19 shows a corrugated blank having a single brace that is hingedly separable from a partition panel of the blank.

FIG. 20 shows an assembled document holding device using the hingedly separated single brace of FIG. 19.

FIG. 21 shows another alternative corrugated blank having side-engaging braces that are separable from a side edge of the blank.

FIG. 22 shows an assembled document holding device using the side-engaging braces of FIG. 21.

FIG. 23 shows an alternative assembled document holding device using the side-engaging braces of FIG. 21.

FIG. 24 shows another embodiment of alternative corrugated blanks having partition panels of trapezoidal shape.

FIG. 25 shows an assembled document holding device assembled from one of the blanks of FIG. 24.

### DETAILED DESCRIPTION OF THE INVENTION

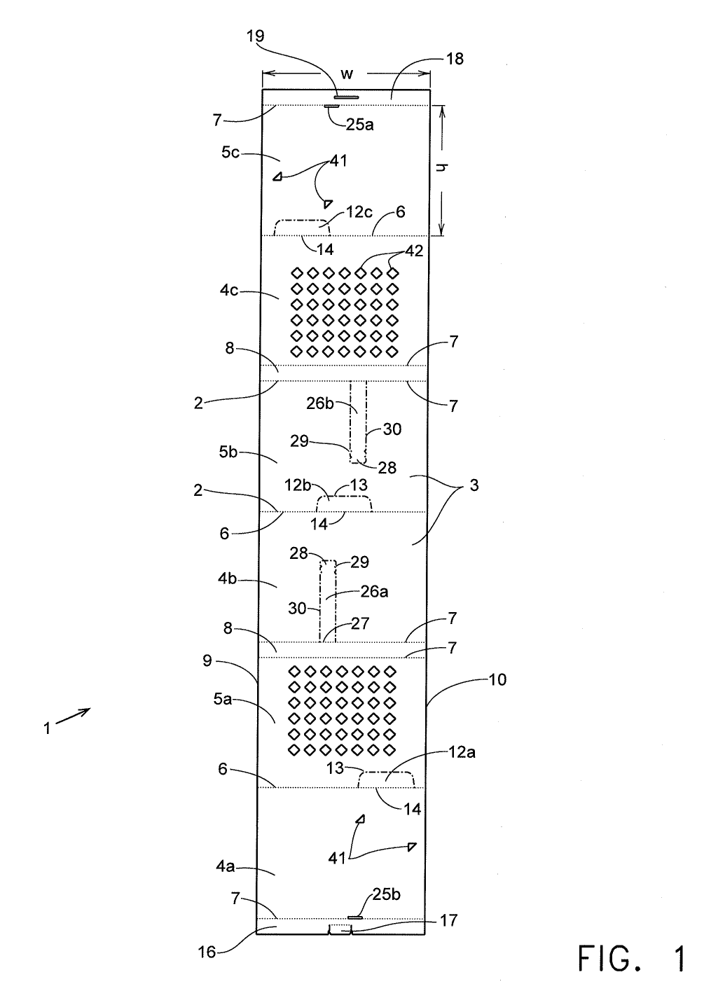

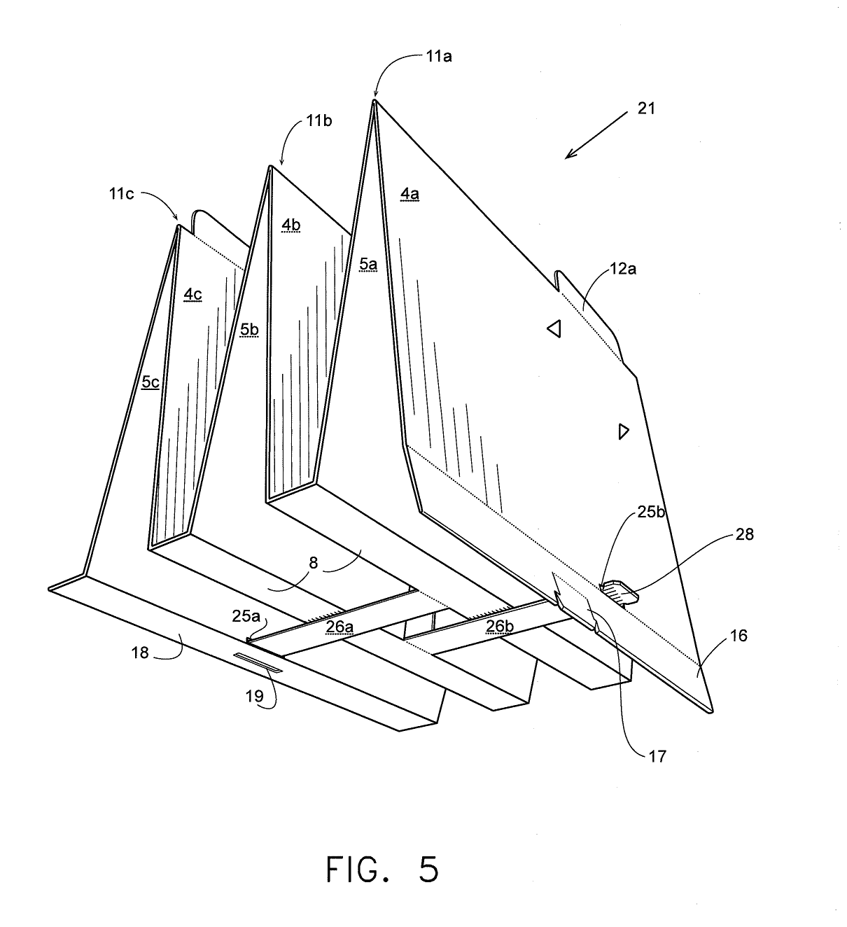

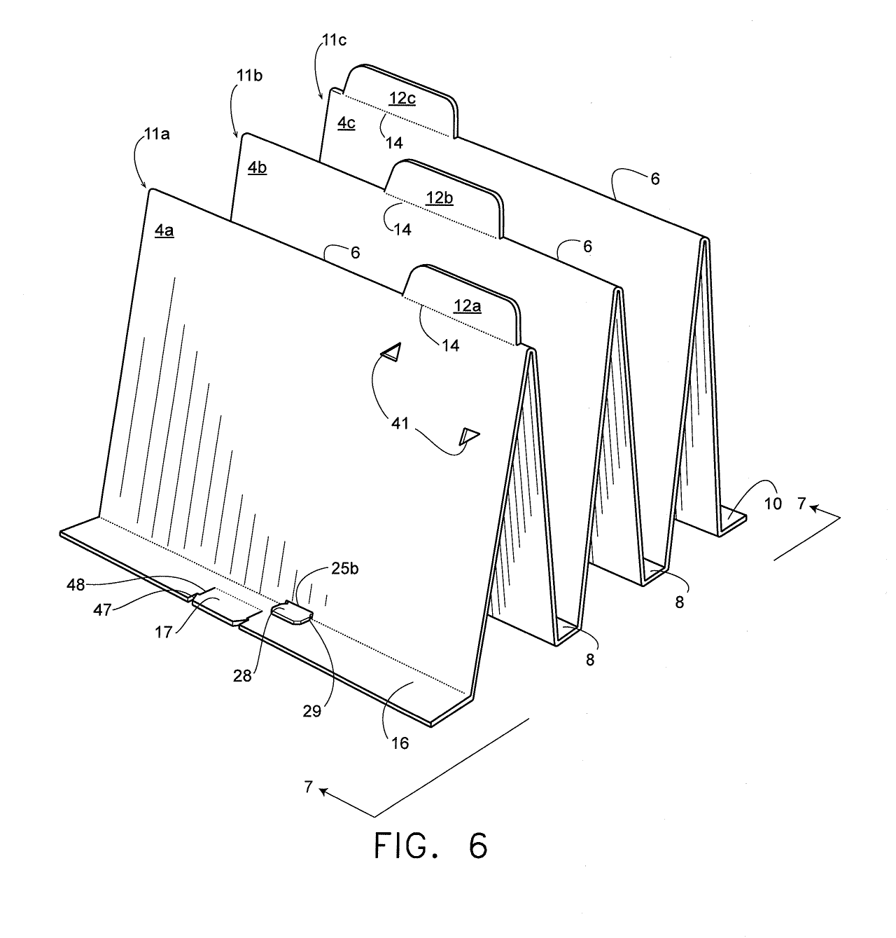

FIGS. 1-4 show a blank 1 that can be assembled by folding into a document holding device shown in FIGS. 5-6. The blank 1 is an elongated rectangular planar material, typically formed from a paperboard or a corrugated paperboard, although the construction material can include plasticized corrugate, and films of metal or plastic, and laminates and composites of any the foregoing and other material suitable for use for forming a container for use as such. A front or forward direction is toward the bottom, while a rear or rearward direction is toward the top.

The blank 1 includes a plurality of transverse fold lines 2 that define a plurality of partition panels 3 arranged end to end, and joined contiguously at opposed end edges. The plurality of panels 3 are unitary with and formed from the same sheet of material, although one or more of the panels can be a separate material that is joined to an adjacent panel with an attachment, such as an adhesive between one panel edge and an overlapping flap of an adjacent panel.

The partition panels 3 include an alternating series of front panels 4, depicted as front panels 4a, 4b, 4c, and rear panels 5, depicted as rear panels 5a, 5b, 5c. Respective top edges of a front panel 4 and an adjacent rear panel 5 are hingedly joined along a top fold line 6, so that the rear panel 5 extends downward and away from the top edge 6. Each pair of front panel 4 and rear panel 5 joined along a top edge 6 defines a partition 11. While the illustrated holding device is illustrated and exemplified using three partitions, or three pairs of front and rear panels, in combination with a brace, the invention also related to a single partition which can be secured into an assembled form with a brace; as well as at least one partition, including two or more partitions, as well as four or more partitions. It is within the skill of a person of ordinary skill to construct holding devices using 1, 2, 4 or more partitions that are assembled with one or two, three, four, or more braces to secure the assembled holding device into the zigzag arrangement.

Respective bottom edges of a front panel 4 and an adjacent rear panel 5 are also hingedly joined along a bottom fold line 7, and are either directly and hingedly joined, or hingedly joined through an bottom spacer panel as described below. The transverse fold lines 2 can be manufactured into the blank as preformed fold lines, and are typically lines of embossment or depression in the thickness of the material that promote folding at the embossment lines. Typically a preformed fold line does not include a cut through a surface or the thickness of the material, which could weaken excessively the joint of the material and result in separation. Alternatively, the fold line can be defined by a line or dashed line printed along the fold line that indicates to the user where to form the fold in the material during the assembly of the document holding device.

In the illustrated blank, the respective bottom edges of the front panels 4 and the adjacent rear panels 5 are joined through an intermediate bottom spacer panel 8. The intermediate bottom spacer panel 8 has rearward and forward edges that are hingedly joined to the bottom edges of the rear panel 5 and the front panel 4, respectively, along a pair of bottom fold lines 7. As shown in FIG. 6, the bottom spacer panels 8 widen the space (in the front to back direction) at the bottom of pockets 22 formed between adjacent partitions 11, and specifically between a rear panel 5 of one partition 11 and a front panel 4 of the adjacent partition 11 in an assembled document holding device 21, to accommodate more documents or files within the partitioned pocket between partitions. The dimensions of the bottom spacer panels 8 in the front to back direction can be all the same or different; the greater the said dimension of a bottom spacer panel, the wider the space at the bottom of a pocket. Typically this dimension is about ½ inch, 1 inch, 1½ inch, or 2 inch.

In a similar way, the top edges of a front panel and a rear panel of a partition can be joined indirectly, typically through a top spacer panel that has a forward hingedly edge joined to the top edge of the front panel, and a rearward edge hingedly joined to the top edge of the rear panel, similar to the bottom spacer panel 8.

The blank also can include a forward spacer panel 16 that is joined to and extends from the bottom edge of the forward-most front panel 4a along a bottom fold line 7. The blank also can include a rearward spacer panel 18 that is joined to and extends from the bottom edge of rearward-most rear panel 5c along another bottom fold line 7. The forward spacer panel 16 and rearward spacer panel 18 can improve the free-standing stability of the assembled document holding device 21. As with the bottom spacer panels 8, the dimensions of the forward spacer panel 16 or the rearward spacer panel 18 in the front to back direction can be the same or different, and can be the same as or different from the bottom spacer panels.

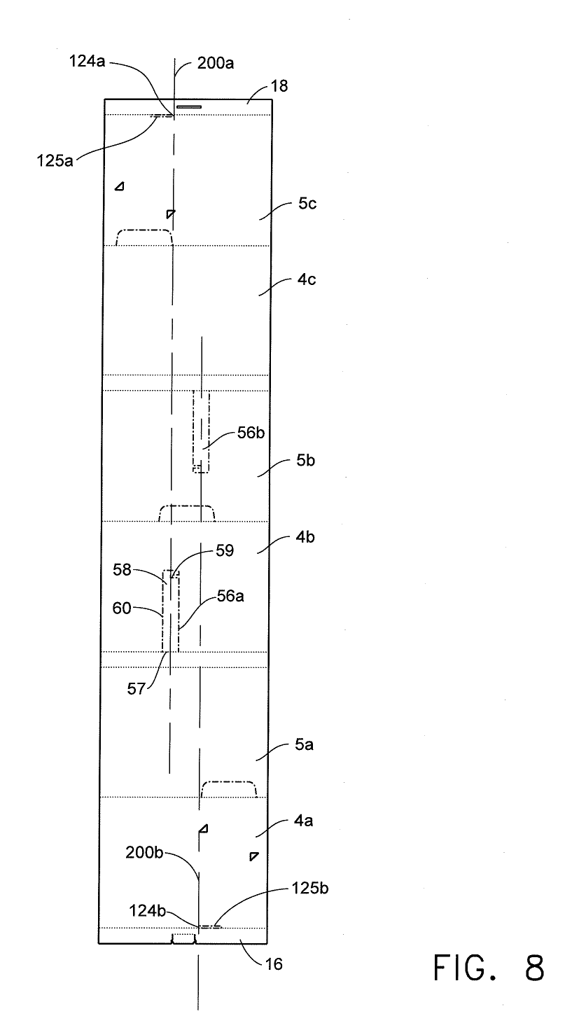

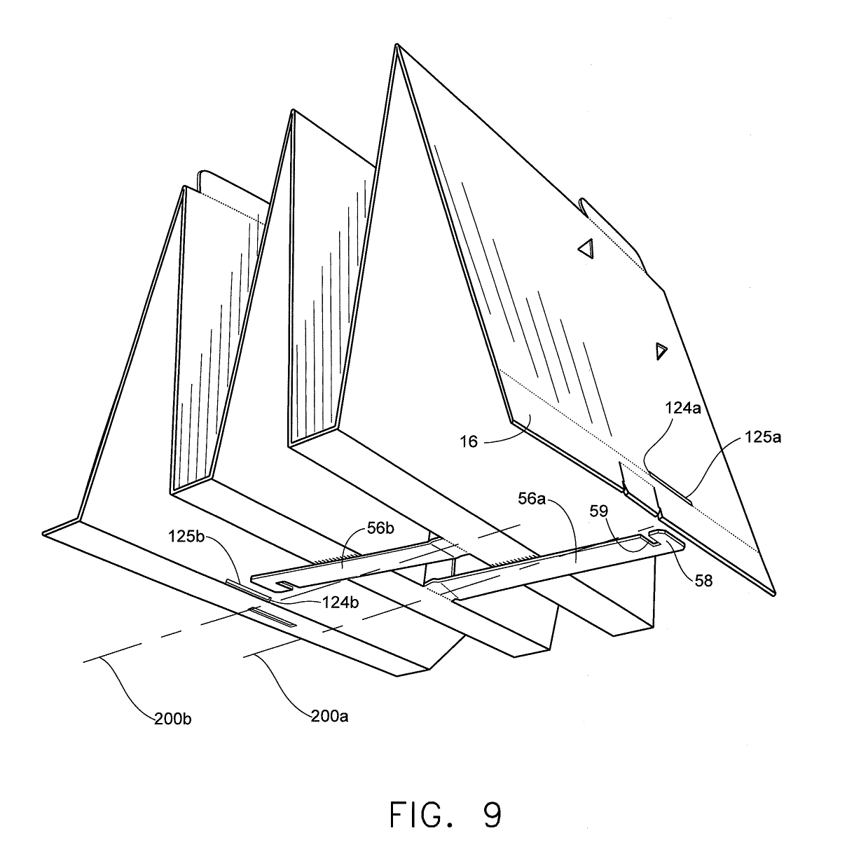

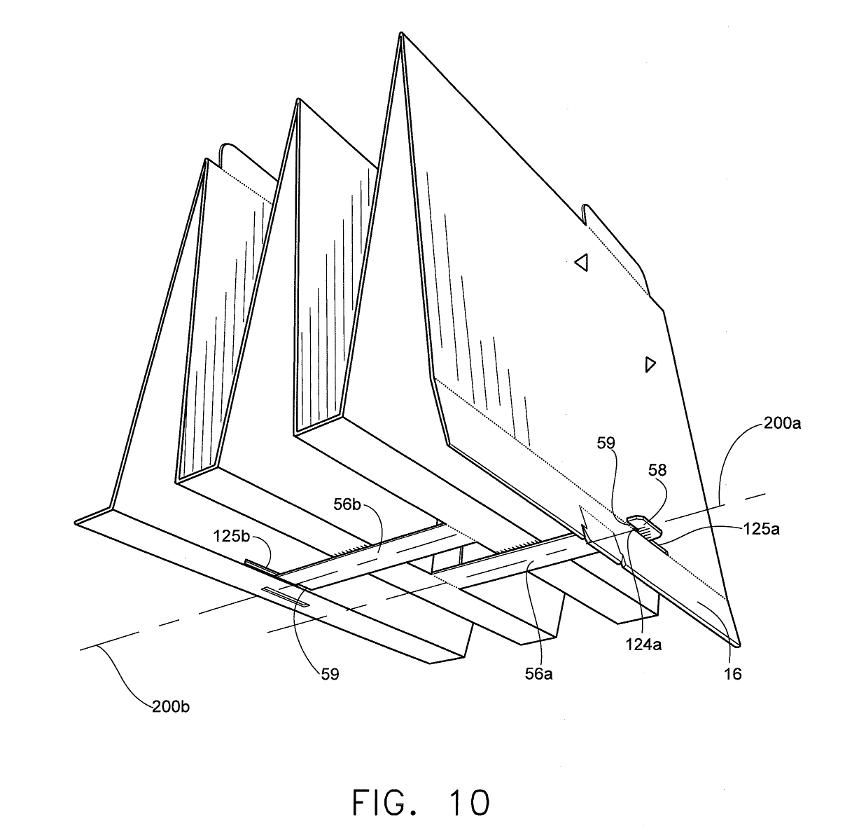

When used within a document box or file drawer, the forward spacer panel 16 and rearward spacer panel 18 set apart the forward-most front panel 4a from the inside surface of the front wall 82, or the rearward-most rear panel 5c from an inside surface of the rear wall 83, to widen the respective pockets 23 and 24 formed with the respective front wall 82 and the rear wall 83 of the document box 80 (FIGS. 8 and 9) or the front wall 92 and the rear wall 93 of the file drawer 90 (FIG. 10).

The present invention further provides a brace for fixing the plurality of partition panels 3 in position in a zigzag pattern. A brace is an elongated member that attaches between and secures together the bottom portion of two or more of the partition panels, to secure the document holding device in assembled form.

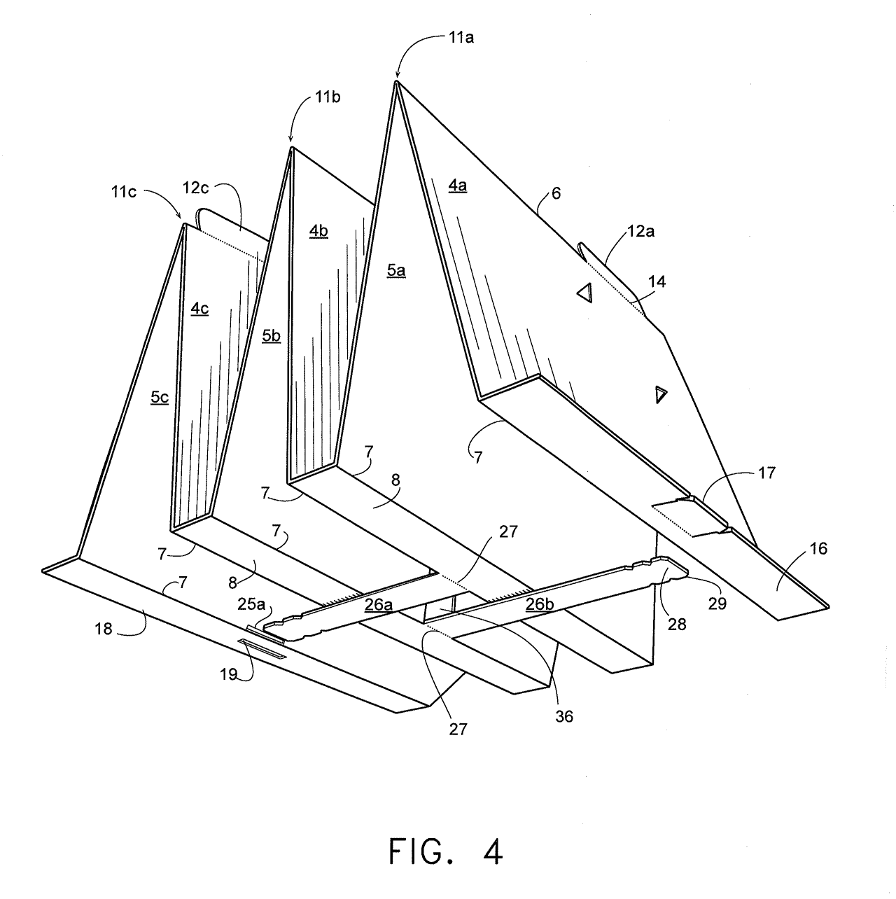

A first embodiment of a brace is shown in FIGS. 4-5. A brace 26 of material has a first end 27 that is attached to a portion of a first partition panel at, or proximate to, its bottom edge, typically near its transverse middle, and is elongated to a distal end 28. The document holding device 21 includes three partitions 11 (11a, 11b, 11c). A first brace 26a attached hingedly at its first end 27 to the bottom edge of the front panel 4b of the second partition 11b. The first end 27 the brace is integral with a material of the bottom edge of the front panel 4b. The first brace 26a extends under the second partition 11b, under the bottom spacer panel 8 between the second partition 11b and the third partition 11c, and into a first slot 25a in, or proximate to, the bottom edge of the rear panel 5c of the rearward-most partition 11c. A second brace 26b is attached hingedly at its first end 27 to the bottom edge of the rear panel 5b of the second partition 11b, and extends under the second partition 11b, under the bottom spacer panel 8, between the second partition 11b and the third partition 11c, and into a second slot 25b in, or proximate to, the bottom edge of the front panel 4a of the forward-most partition 11a. The first brace 26a is formed from an elongated vertical portion of front panel 4b, and is separable along a separation line 30 that separates the brace 26a, or permits manual separation of the brace 26a, from the front panel 4b. Upon separation of the brace, an elongated vertical opening 36 is formed in the front panel 4b. Likewise, the second brace 26b is formed from a portion of the rear panel 5b and is separable along the corresponding separation line 30 that separates the brace 26b, or permits manual separation of the brace 26b, from the rear panel 5b. The separation lines 30 are typically a pre-formed score line, and is typically a continuous or intermittent cut line formed through at least a portion of, and typically completely through the surface, or surfaces, and the thickness of the corrugated material of the panel, so that the elongated body and distal end 28 of the brace(s) 26 can be freed from the partition panels.

The illustrated brace 26 also includes one or more protrusions 29 extending laterally outward from either or both side edges, including along the distal end 28, which are laterally dimensioned for frictional insertion into the slots 25. The lateral protrusions 29 provide a means for improving the attachment of the distal end 28 of the braces 26 within the slot 25. The protrusions 29 on one of or both opposite sides of the distal end 28 are slightly wider laterally than the width of the slot 25, so that the distal end 28 of the brace 26 can be forced through, and remain engaged in, the slot 25 by frictional force between the protrusions 29 and the material of the partition panels defining the slots 25. The plurality of protrusions along a side of the distal end 28 also allows the user to set the inserted tab 28 to two or more different inserted positions, allowing adjustability of the spacing between the bottoms of the partition panels and/or the tilt angles of the partition panels.

As illustrated in FIG. 4-5, the crossing of the braces 26a and 26b between the first and second bottom spacer panels 8 improves the stability of the assembled partition panels 3 and minimizes their forward and rearward movement. It has also been shown that the placing of heavy document, files or books into the pockets increases the frictional force between the bottom spacer panels 8 and the braces 26, which further limits their forward and rearward movement and improves stability.

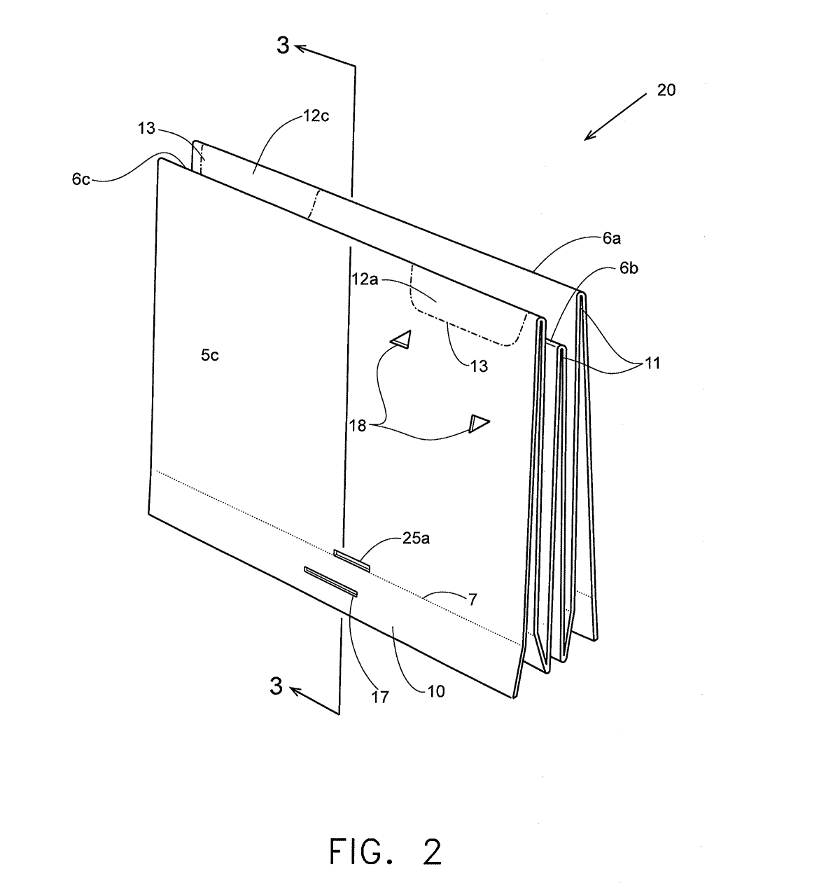

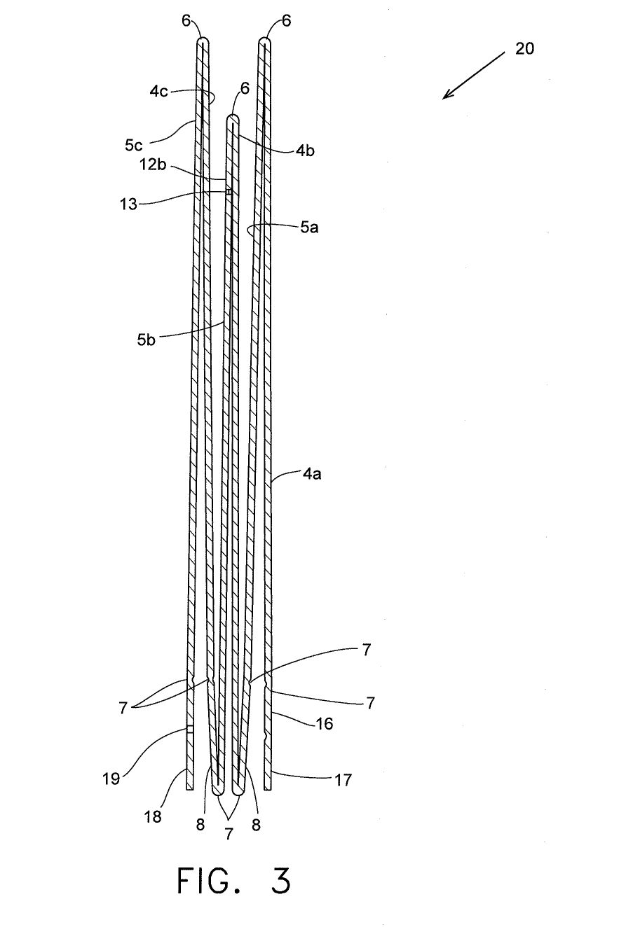

FIGS. 1-5 show the assembly of a manufactured blank 1 into a document holding device. Blanks of corrugated board are printed, scored and punched out into an individual blank 1. The folding of partition panels 4 and 5 along fold lines 6 and 7 forms a pre-folded partition device 20 as an article of manufacture, shown in FIGS. 2 and 3. One, two or more of the pre-folded partition devices 20 can be packaged, along with appropriate assembly instructions, for marketing and sale.

The user then expands and manipulates a pre-folded partition device 20 at the top fold lines 6 and bottom fold lines 7 to begin forming the zigzag arrangement of partition panels 3, forward spacer panel 16, rearward spacer panel 18, and intermediate bottom spacer panels 8. The user then separates braces 26a and 26b from their respective panels (front panel 4b and rear panel 5b), leaving an elongated opening 36 in these panels. The braces 26a, 26b are passed under the adjacent bottom spacer panels 8, and the distal ends 28 are inserted into corresponding slots 25a, 25b at the bottoms of partition panels 5c and 4a, as shown in FIGS. 4 and 5. The resulting free-standing document handling device 21 shown in FIG. 6 can be used on a furniture top or in a document box or drawer to hold documents, files, etc.

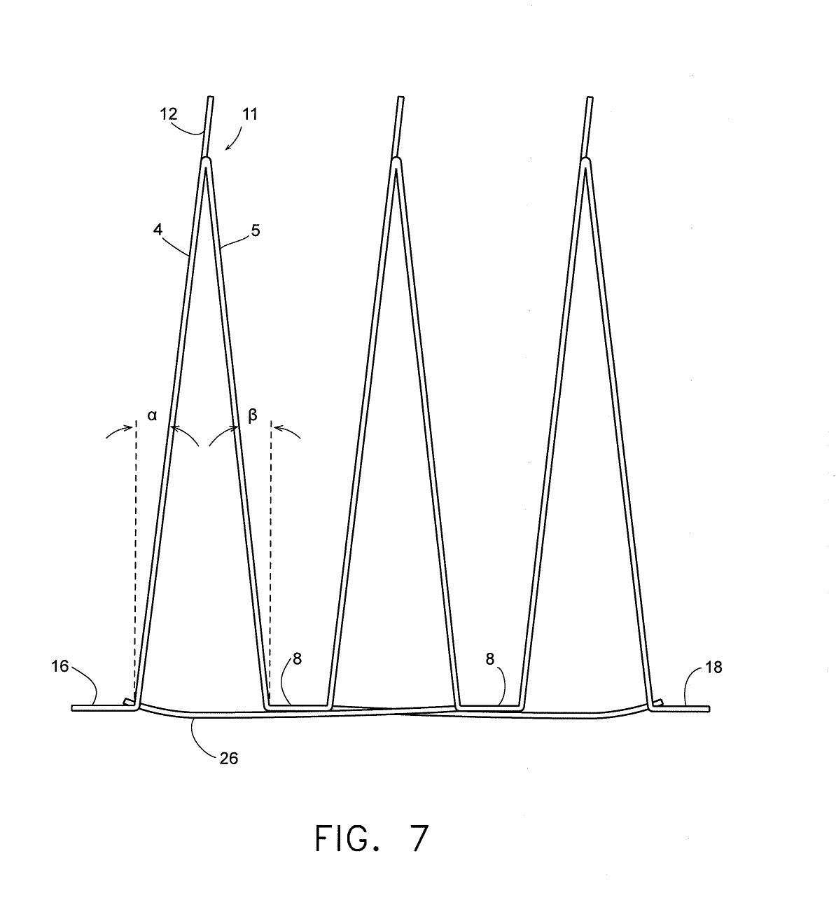

FIG. 7 shows the tilt angle α (alpha) from vertical of a front panel 4, as typically about 90° and less, more typically about 85° and less, and typically not less than about 70°, more typically not less than 80°. Likewise, the tilt angle β (beta) from vertical of a rear panel 5 is typically about 90° or less, more typically about 80° and less, and typically not less than about 70°, more typically not less than 80°. The tilt angles α and β can be the same, or different, and if different, typically the tilt angle α is greater that the tilt angle β. An alternative embodiment of a brace is shown in FIGS. 8-10. A brace 56 of material has a first end 77 that is attached to a portion of a first partition panel at, or proximate to, its bottom edge, typically near its transverse middle, and is elongated to a distal end 58. The distal end 58 of the brace 56 includes a notch 59 that extends laterally through the width of the distal end 58, for engaging and attaching to a portion of a bottom portion of a second partition panel.

The first end 57 of a first brace 56a is integral with a material of the bottom edge of the front panel 4b. The first brace 56a extends under the second partition 11b, under the bottom spacer panel 8 between the second partition 11b and the third partition 11c. The distal end 58 of the first brace 56a is inserted partially through a slot 125a formed in a partition panel 5c at, or proximate to, its bottom edge, and then manipulated laterally so that the notch 59 of the first brace 56a engages or hooks onto an edge 124b of the partition panel 5c that defines the slot 125b. A second brace 56b is attached hingedly at its first end 27 to the bottom edge of the rear panel 5b of the second partition 11b, and extends under the second partition 11b, under the bottom spacer panel 8, between the second partition 11b and the third partition 11c, and into a second slot 125b in, or proximate to, the bottom edge of the front panel 4a of the forward-most partition 11a, engaging the edge 124b of the partition panel 4a that defines the slot 125b.

To promote a secure attachment of the distal end 58 of brace 56 to the edge 125 of the slot 125, the lateral depth of the notch 59 extends to a longitudinal line 200 oriented in the longitudinal direction of the blank (FIG. 8), while edge 124 of the corresponding slot 125 aligns substantially with the along the same longitudinal line 200. To insert the end 58 of the brace 56 through the slot 125, FIG. 9 illustrates the brace being biased laterally, such as by hand, against the native resilience of the brace material to twisting in the plane of the blank, so that the centerline of the brace 56 angles away from the longitudinal line 200, and the full wide of the distal end 58 aligns with and can be inserted through the opening of the slot 125. As then shown in FIG. 10, after insertion, the notch 59 is aligned with the partition panel, and the resilience of the brace material forces the distal end 58 to its initial unbiased position, with its centerline aligned with the longitudinal line 200, and the notch 59 encompassing the edge 124 of the partition 5. The resilience of the brace to twisting in the plane of the corrugated material prevents the end 58 of the brace from un-hooking from the edge 124 of the partition panel during ordinary use of the document holding device. The brace 56 can be formed as a separable portion of a partition panel.

In subsequent embodiments of a brace described and illustrated herein, an attachment end of the brace using the notch of the second embodiment that engages a slot 125 in a partition panel can be used in place of, or in combination with, the brace and slotted partition panel of the first brace embodiment.

The corrugate and sheet material is a sheet material that has a thickness and resiliency sufficient to maintain the sheet shape in ordinary use. The fold lines between partition panels and other panels of the device enable the panels to hinge at the fold line for assembly from a flattened blank, and for flattening back to a blank shape from an assembled form. In the case of most corrugates and plastic sheets, an embossment can be used as the means for hinging along the fold line. Plastic sheeting that is up to about 50 mil (0.050 inch) can generally be embossed and folded manually along a defined line or pattern.

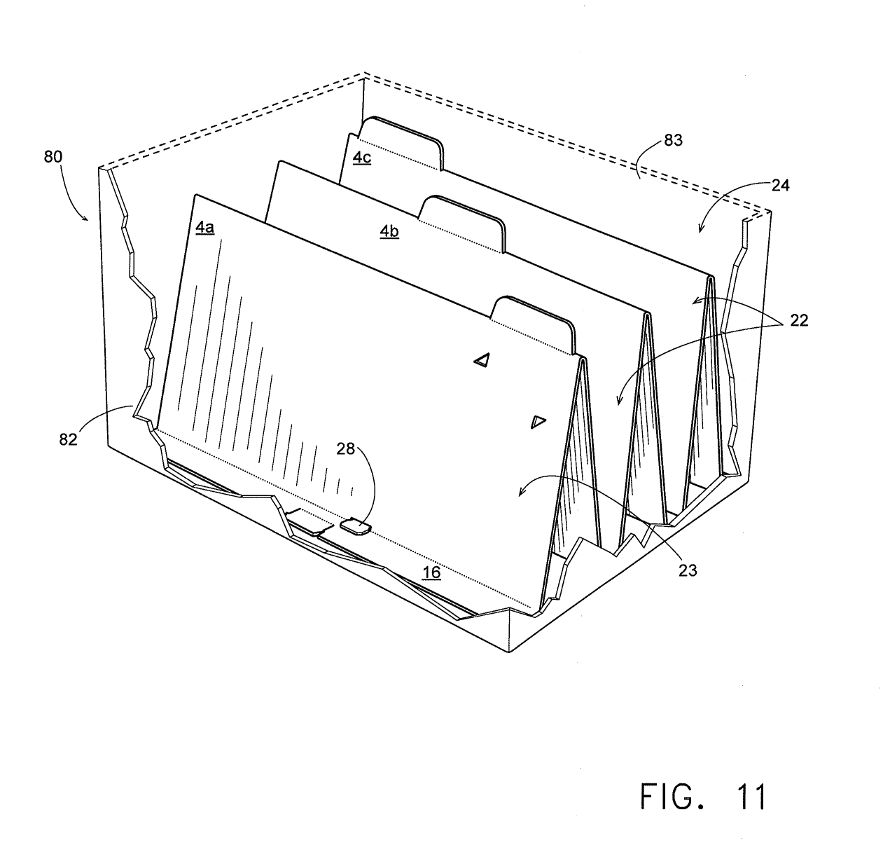

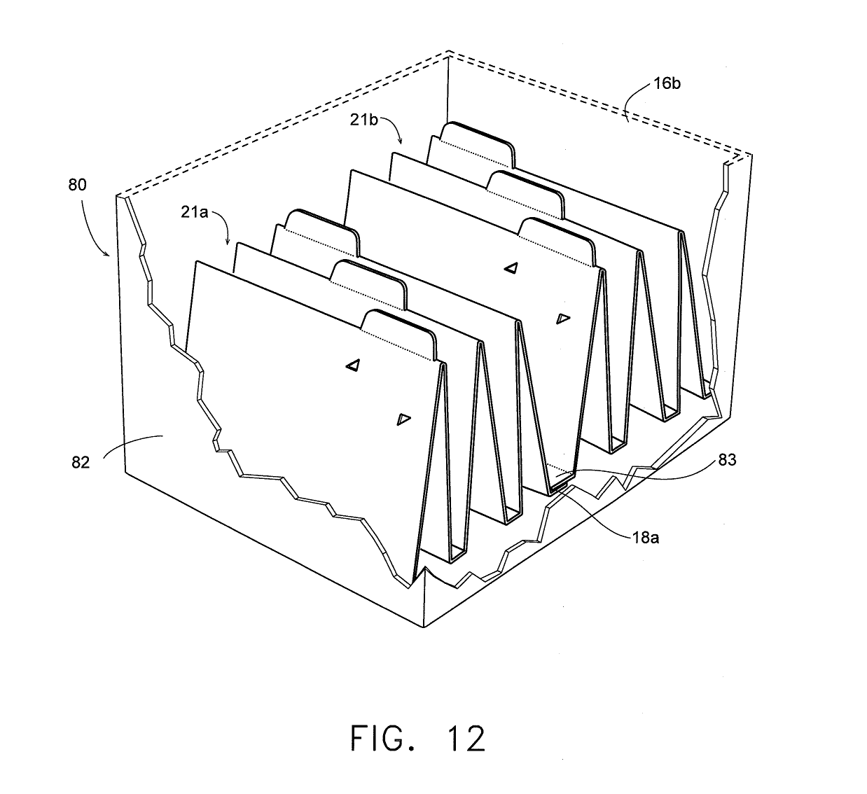

The height (h) and width (w) of a panel 3 can be varied to accommodate various use needs. For a document holding device designed for insertion into a standard file box, such as box 80 illustrated in FIG. 11, with the width of the document holding device transverse to the short dimension of the file/storage box, the height (h) of the panel is typically about 8 to about 9 inches, depending on the desired or designed tilt angles of the panel(s), and the width (w) of the panels is about 8.5 to about 14 inches. This design is termed a legal paper-sized design, sized sufficiently to hold documents of the standard legal paper size of 8.5 inches by 14 inches. For a document partition designed for insertion into the standard file box, such as box 80 illustrated in FIG. 12, with the width of the document holding device transverse to the long dimension of the banker's box, the height (h) of the panel is typically about 8 to about 9 inches, depending on the desired or designed tilt angles of the panels, while the width (w) of the panels is about 9.5 to about 11.5 inches. This design is termed a letter paper-sized design, sized sufficiently to hold documents of the standard letter paper size of 8.5 inches by 11 inches.

In an alternative and converse embodiment, a brace 26 or 56 can be hingedly attached at, or proximate to, the bottom edge of the rear panel 5 of the rearward-most partition, and insertively attaches at its distal end into a slot 25 in, or proximate to, a bottom edge of the front panel 4b of the second partition 11b Another brace 26 can be hingedly attached to, or proximate to, the bottom edge of the front panel 4a of the forward-most partition 11a, and insertively attaches at its distal end into a slot in, or proximate to, a bottom edge of the rear panel 5b of the second partition 11b.

In the illustrated embodiment, the length of the brace 26 is configured to span the distance between at least two, and alternatively at least three, bottom spacer panels or bottom folds of an assembled document holding device. In the illustrate embodiment, the brace is formed and separated from a portion of a partition panel. Typically the length of the brace 26 is substantially less than the vertical height of the partition panel 3, and more typically the length of the brace 26 is less than 80%, including 70% or less, and 60% or less, of the height of the panel 3. An excessive length of the brace material removed from the material of the partition panel 3 may weaken the partition panel strength.

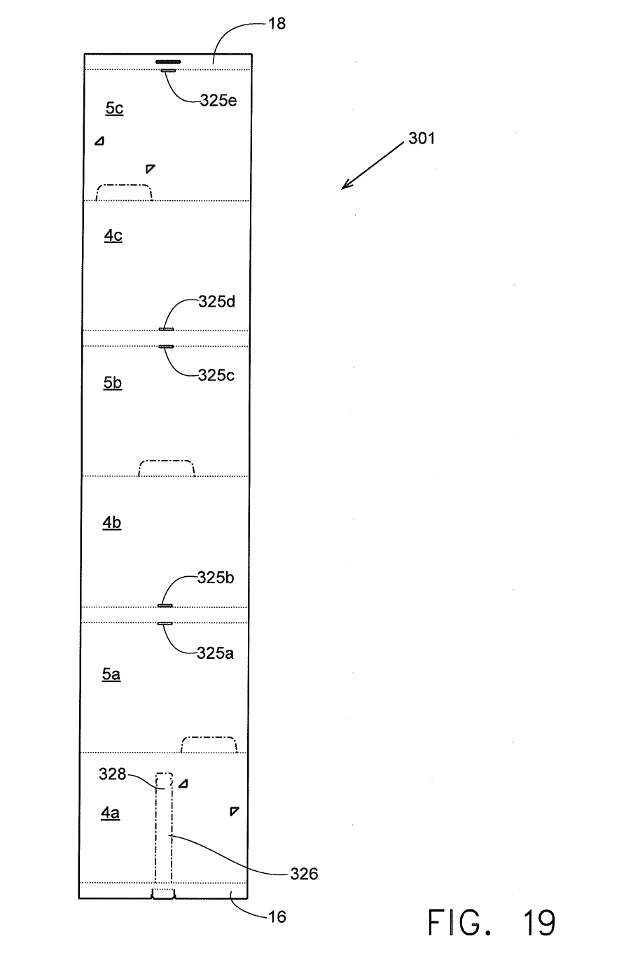

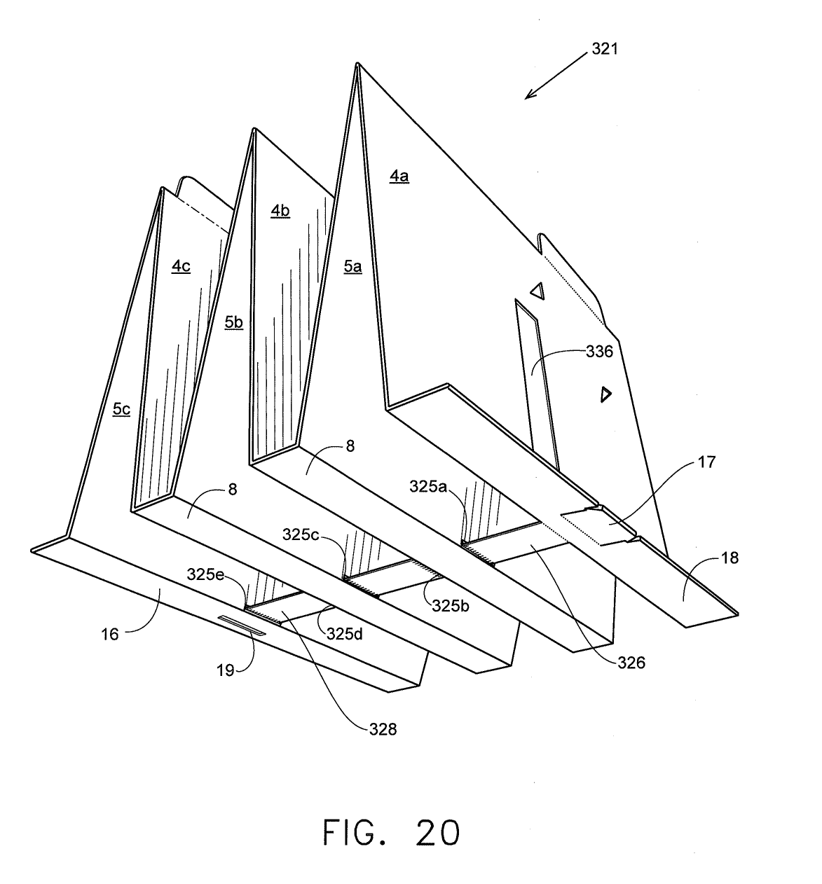

In another embodiment of a brace shown in FIGS. 19 and 20, a blank 301 includes a single, more elongated brace 326 that is hingedly and integrally attached to, or proximate to, the bottom edge of either the rearward-most partition panel (rear panel 5b), or the forward-most partition panel (front panel 4a). The vertical height of the single brace 326 is sized to span all of the front-to-rear bottom folds 7 and bottom spacer panels 8 of the assembled document holding device 321.

In one assembly of the document holding device 321, the separated distal end 328 of the hinged brace 326 is threaded in series through a plurality of aligned slots 325 in the bottom portions of the contiguous partition panels 3. The brace 326 can have protrusions as described herein above. The slots include slot 325a in the bottom of partition panel 5a, slot 325b in the bottom of partition panel 4b, slot 325c in the bottom of partition panel 5b, slot 325d in the bottom of partition panel 4c, and slot 325e in the bottom of partition panel 5c. Alternatively, the single, more elongated brace 326 can loop under any one or all of the intermediate bottom edges 7 of the partitions, with the distal end 328 inserted into the slot 325e in the most remote partition panel.

It can be understood that the attachable ends of the more elongated brace 326 illustrated in FIGS. 19 and 20 can be configured similarly to the brace 56 inserted into and engaged with edges 124 of slots 125 in the bottom portions of the partition panels, as described herein and shown in FIGS. 8-10.

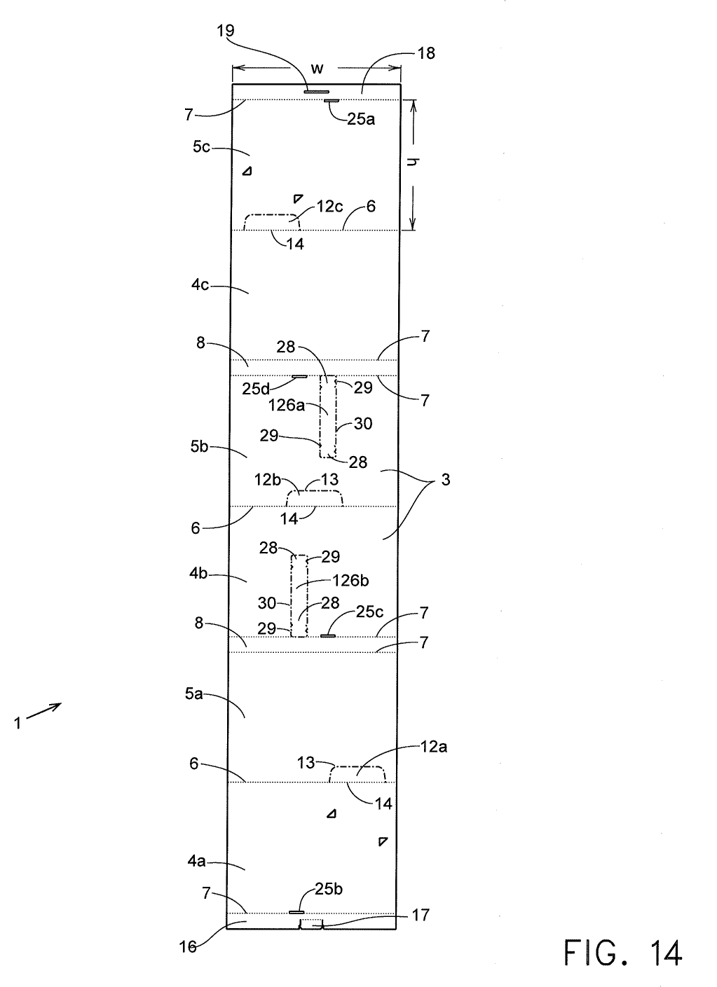

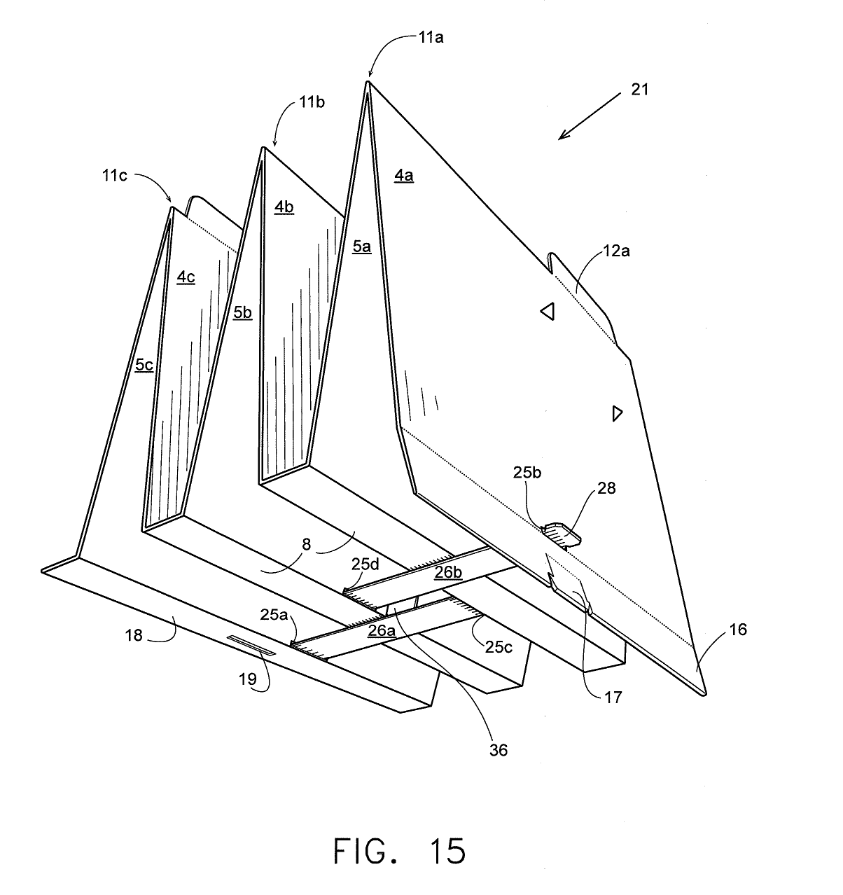

In yet another embodiment of a brace of the invention, a brace is a completely separable and removable from the material of a partition panel 3 in the blank 1, as shown in FIG. 14, rather than being separable only along three sides with a residual attached hinge. Each brace 126 has opposing ends 128 with protrusions 129 along all or a portion of the length for frictional engagement into slots in the bottom portions of the partition panels. As shown in FIG. 15, each of the completely separated braces 126a and 126b can be assembled with the opposed ends 28 inserted into slots 25a and 25c, and slots 25b and 25d, respectively.

An aspect of the brace system of the invention is that the assembled document holding device 21 can be stabilized into a self-standing position without any attachment of the side edges 9, 10 of the partition panels to a respective side edge 9, 10 of an adjacent panel, or to any other structure in which it is placed or associated.

In another embodiment of a brace, an elongated member can be separable at the peripheral end or side edge of a blank. The length of the separated brace is sufficient to extend the front-to-back length or a portion thereof of the assembled document holding device.

It can be understood that the attachable ends of the separable and removable brace 126 illustrated in FIGS. 14 and 15 can be configured similarly to the brace 56 inserted into and engaged with edges 124 of slots 125 in the bottom portions of the partition panels, as described herein and shown in FIGS. 8-10.

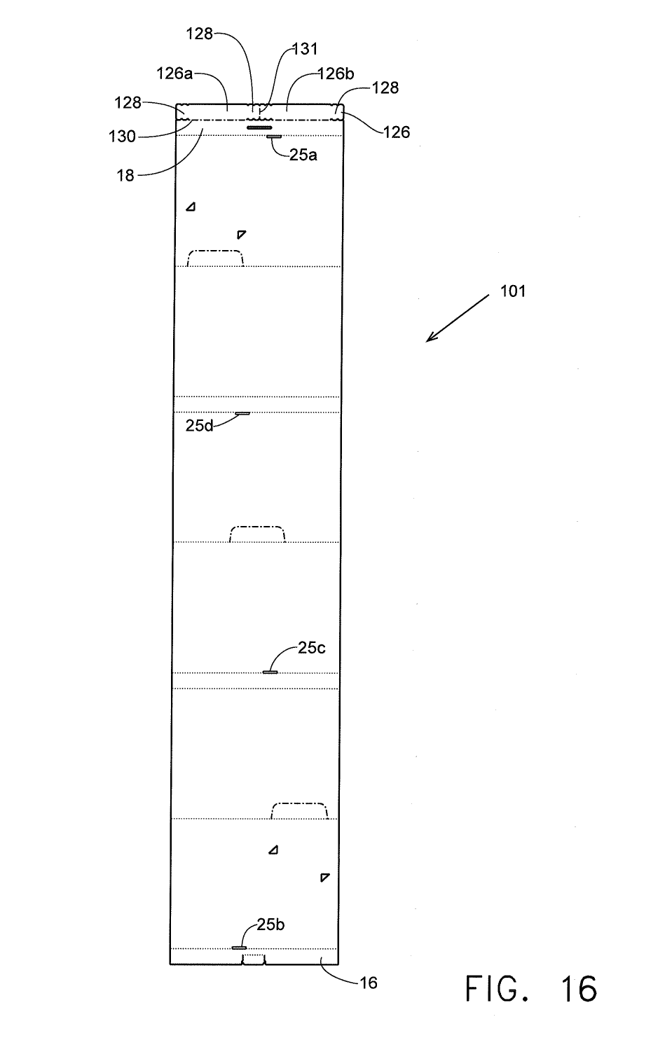

In yet another embodiment shown in FIG. 16, a blank 101 includes a separable elongated brace 126 that is separable along a lateral score line 130 from one end of the main portion of the blank 101. The separated brace 126 itself is then separable along a second score line 131 into two parts, a first brace 126a and a second brace 126b, each having opposing ends 128 with protrusions 129 along all or a portion of the length for frictional engagement in slots of the partition panels. Assembly of these separated braces 126 with the partition panels 3 is substantially as depicted for braces 26a and 26b in FIG. 15.

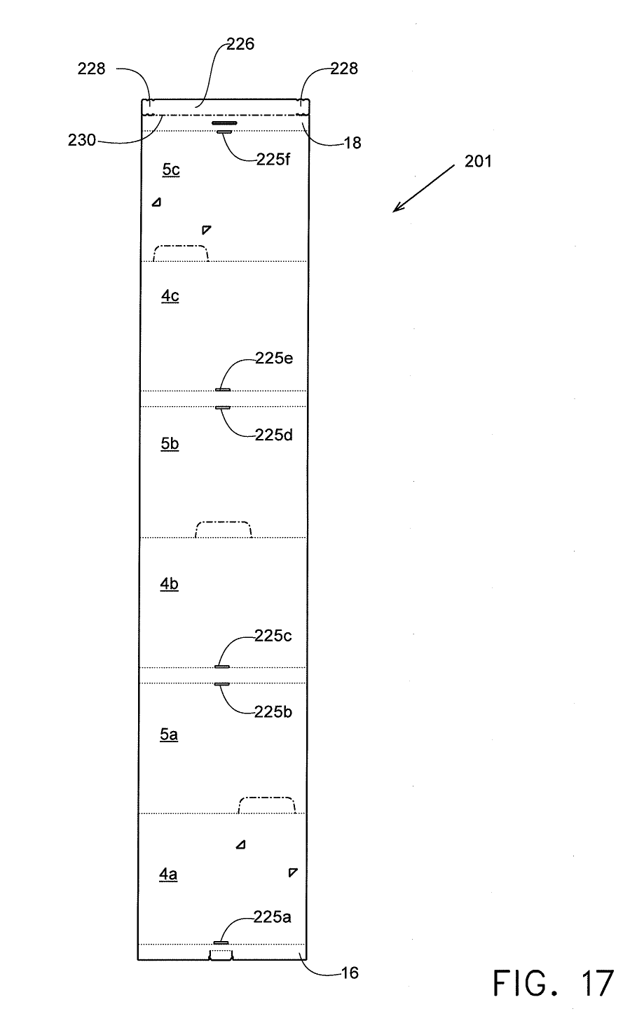

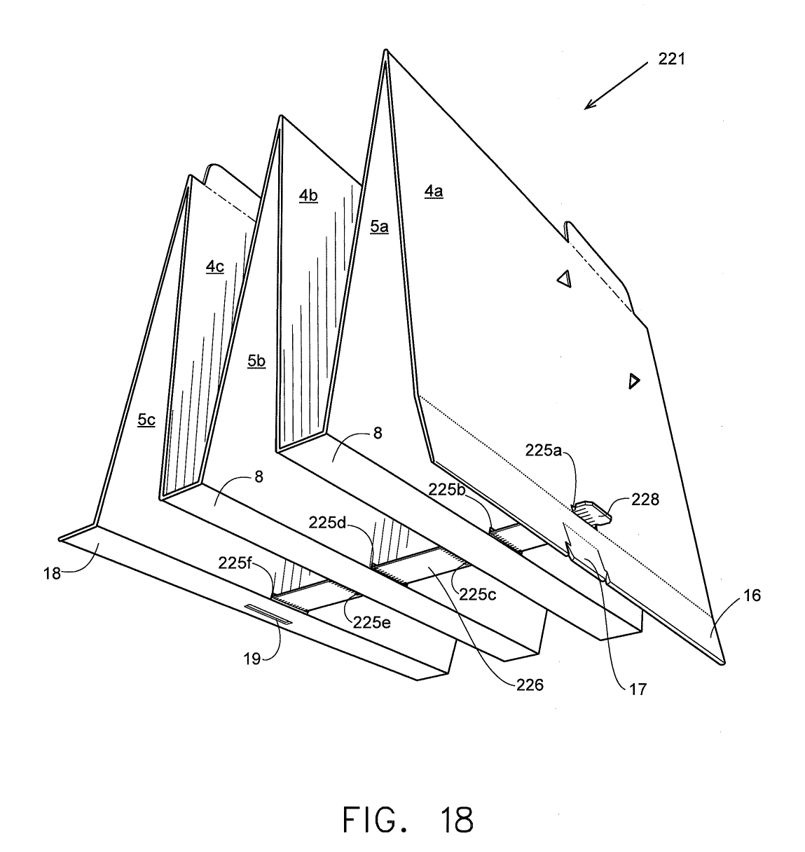

In another embodiment shown in FIGS. 17-18, a blank 201 includes a separable elongated brace 226 that is separable along a lateral score line 230 from one end of the main portion of the blank 201. This blank 201 includes a series of aligned slots 225 formed in the bottom portions of the partition panels 4 and 5. The slots include slot 225a in the bottom of partition panel 4a, slot 225b in the bottom of partition panel 5a, slot 225c in the bottom of partition panel 4b, slot 225d in the bottom of partition panel 5b, slot 225e in the bottom of partition panel 4c, and slot 225f in the bottom of partition panel 5c. The separated brace 226 has opposing ends 228, and one or both side edges of the brace 226 can include protrusions 229 along all or a portion of the length for frictional engagement with the slots of the partition panels. In one assembly of a document holding device, the elongated brace 236 is threaded in series through a plurality of aligned slots 225 in the bottom portions of the contiguous partition panels 3, as depicted in FIG. 18. Alternatively, the single brace 226 can be looped under any one or all of the intermediate bottom edges 7 of the partition panels with the distal edge 228 inserted into the remote-most slot 225.

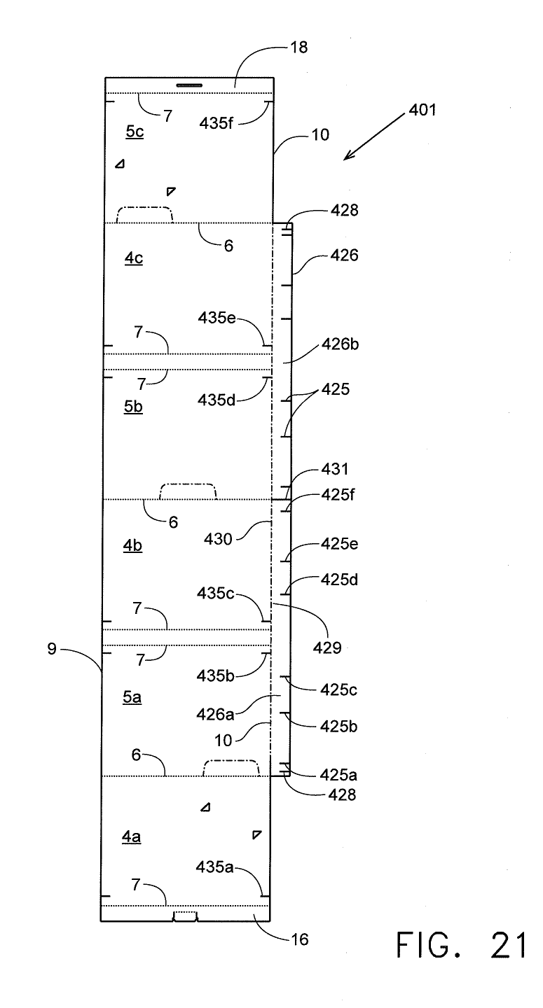

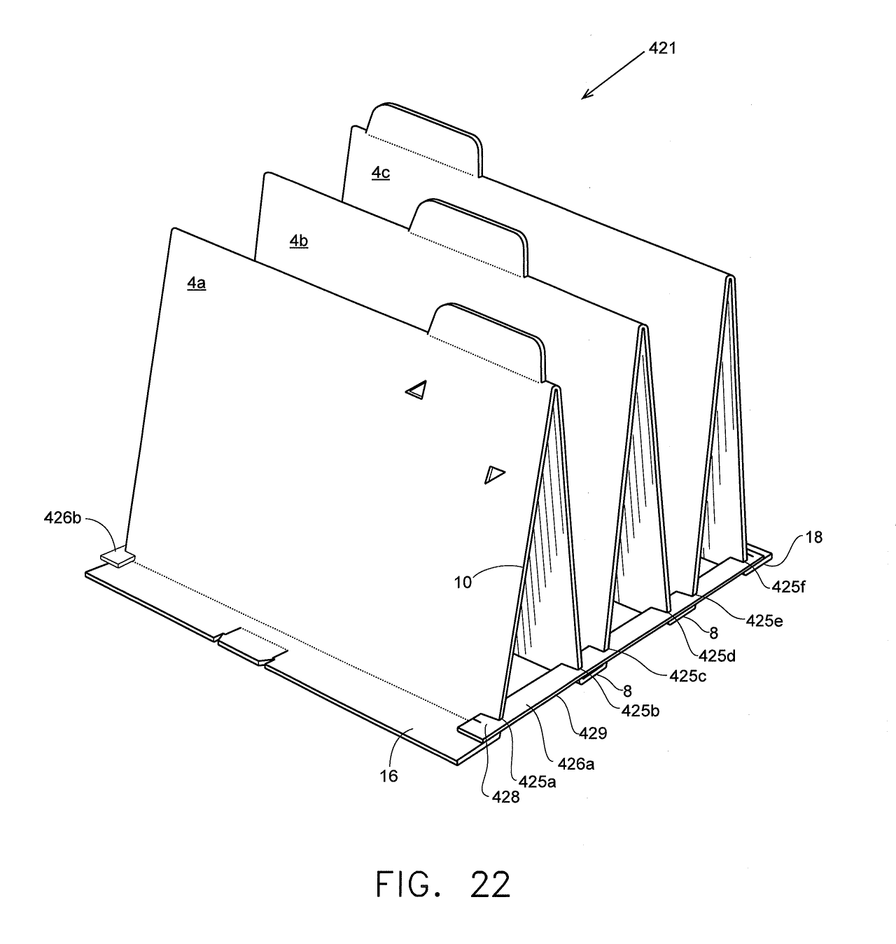

In a non-limiting additional embodiment of a document holding device with a brace, the brace provides a means for securing the bottom portions of the partition panels at either or both of the side edges of a partition panel. FIG. 21 shows a blank 401 that includes a separable elongated member 426 that is separable along a score line 430 from along one side of the main portion of the blank 401. The separated elongated member 426 is then separable along a second transverse score line 431 into two parts, a first brace 426a and a second brace 426b. Along one edge of each of the first brace 426a and the second brace 426b are a plurality of transverse slits 425 formed to a depth through the width of the braces. The width of the transverse slits 425 are typically slightly less than the thickness of the corrugated material, to ensure a frictional fitting and attachment. In an assembled document holding device 421 shown in FIG. 22, the slits 425 of the two braces 426 are pressed over the opposite side edges 9 and 10 of the plurality of partition panels 3, proximate the bottom fold lines 7, so that the edges 9 and 10 of the partition panels 4a, 5a, 4b, 5b, 4c, and 5c are held in place in a front to back direction by the brace slits 425a, 425b, 425c, 425d, 425e, and 425f respectively. The spacing of the slits 425 corresponds to the designed front-to-rear spacing between the bottom folds 7 of the partition panels. Additional slits 428 can be spaced along the edge of the brace 426 to allow the user to adjust the spacing between the bottoms of the partitions panels and/or the tilt angles of the partition panels.

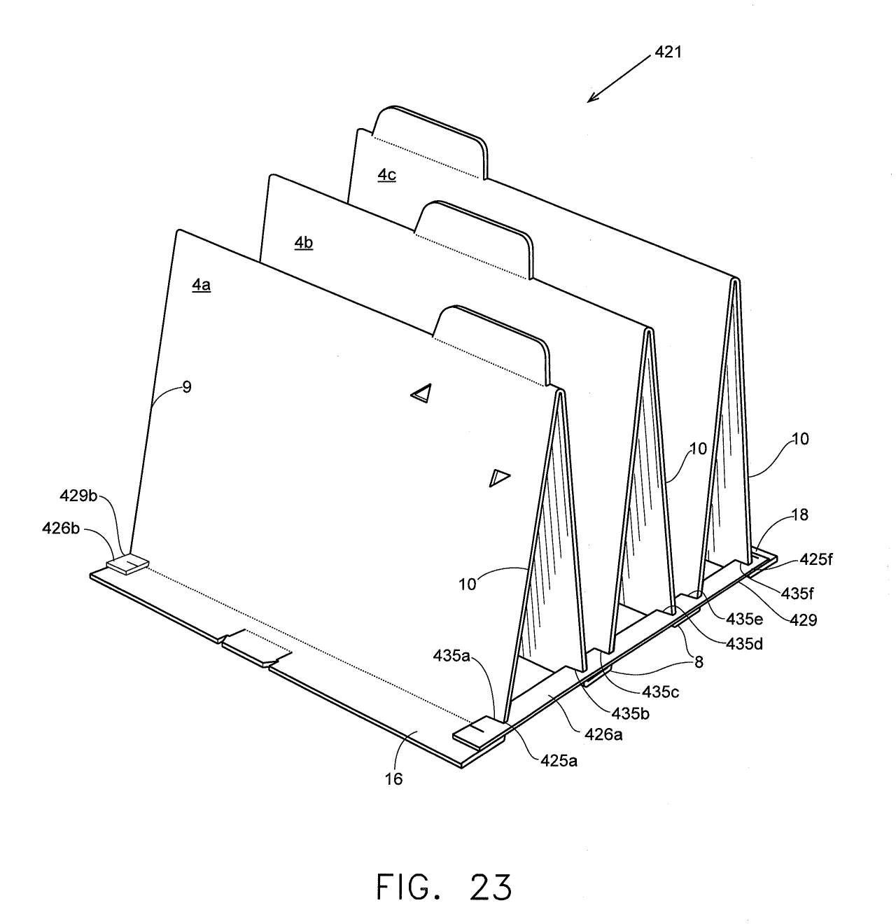

Optionally, corresponding lateral slits 435 are formed in the blank to a depth laterally along the side edge 9, 10 of the partition panels, proximate the bottom fold lines 7, typically up to about Y2 inch from the fold line 7. As shown in FIG. 23, the slits 425 of the braces 426 can engage the slits 435 in the side edges 9 and 10 of the partition panels, to more securely affix the braces 426 to the partition panels, and to bring an outer edge 429 of the braces 426 approximately flush with the side edges 9 and 10 of the partition panels.

The blank 1 and the document holding device formed therefrom can also include a plurality of label tabs 12 that extend from a top edge of the front panels 4. The label tabs 12 are formed from a portion of the rear panels 5, and are attached to the top edge of the front panels along an edge 14. The label tab 12 is defined by a separation line 13 that separates the label tab 12, or permits manual separation of the label tab 12, from the rear panel 5. The separation line 13 is typically a pre-formed scored line, and is typically a continuous or intermittent cut line formed through at least a portion of, and typically completely through, the thickness of the corrugated material.

In the illustrated embodiment, the label tabs 12a and 12b include a proximal edge 14 that is joined to the top edge of the adjacent front panels 4a and 4b, proximate the top fold line 6. The top fold line 6 can extend through label tabs 12a and 12b along the proximal edge 14. During manufacturing, the label tab 12 can also be folded over when the front panel and rear panels are folded over into the pre-folded partition device 20, shown in FIGS. 2-3. In this embodiment, the label tab 12 will have a folded attachment to the front panel 4.

In an alternative embodiment, the label tab 12c includes a proximal edge 14 that extends from the top edge of the adjacent front panel 4c without a fold line. That is, the top fold line 6 joining the front panel 4c and the rear panel 5c is formed laterally away from both sides of the label tab 12c, but not along the proximal edge 14 of label tab 12c, so that the label tab 12c extends from and in the same plane as the front panel 4c, without a crease, seam or fold line. The front panel 4 can be folded over the rear panel 5 without folding over the label tabs 12. Prior to folding, the label tab 12 is separated from the rear panel 5 along score line 13 to avoid its folding over when the rear panel 5 is folded away from the front panel 4. This provides a label tab with a seamless, smooth transition to the front panel 4. Some, none, or all of the label tabs 12 can include the fold line along the proximal edges, and some, none or all of the label tabs 12 can have no fold line.

The dimensions and shape of the label tabs 12 can be any of those commonly used in the folder and file arts. The positioning of the label tabs 12 along the top edge of the partition panels 3 can also be as commonly done in the folder and file arts. In the illustrated embodiment, the label tabs have width of about 20% to 35% of the width of the partition panel, and are positioned along the top edges of the contiguous partition panels in an ordered fashion from right side to left side.

In another aspect of the invention, two or more document holding devices can be assembled in series. FIG. 12 provides an example of two document holding devices attached in series. The document holding device can include means associated with the forward end and/or rearward end of a document partition, for fastening or associating the front end of a first document holding device with the opposite end of a second document holding device, to link the two document holding devices in series. FIGS. 1, 5, 6 and 9 illustrate first document holding device including a fastening tab 17 disposed at the leading edge of the forward spacer panel 16, that registers with and fastens through a corresponding slot 19 disposed in the rearward spacer panel 18 of a second, with the two document holding devices positioned in series within a file cabinet drawer. The fastening tab 17 is formed from the forward spacing panel 16 by cutting the opposite sides of the fastening tab 17 and leaving a proximal portion of the fastening tab 17 hingedly connected to the forward spacing panel 16. The opposite sides 47 of the fastening tab 17 taper to an undercut shoulder 48. The tapered sides 47 aid in inserting the fastening tab 17 into the fastening slot 19, while the shoulders 48 prevent the inserted tab 17 from easily pulling out from the slot 19.

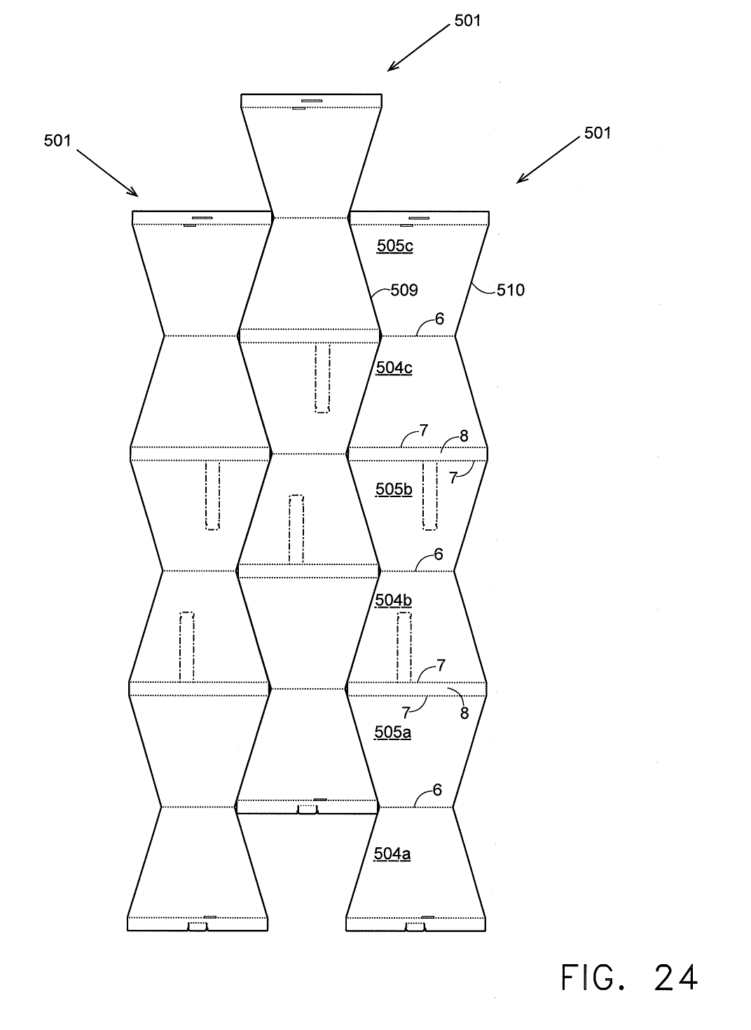

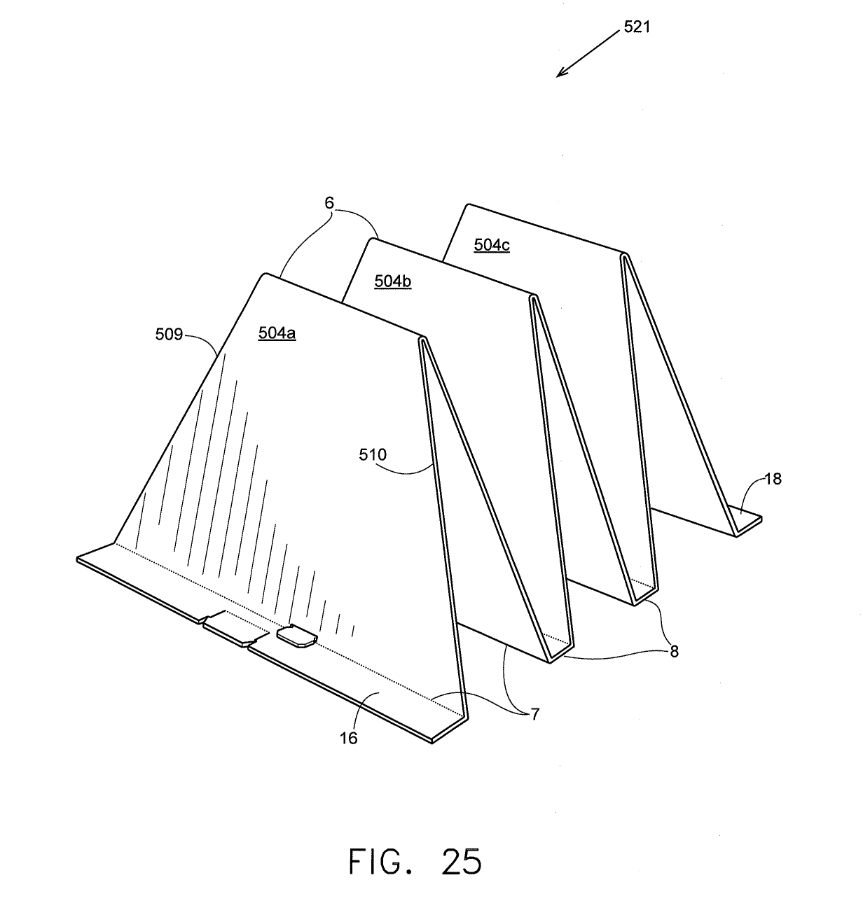

Another aspect of the invention is that the partition panels can have other shapes than rectangular, including shapes with side and top edges that are trapezoidal or arched. FIGS. 24 and 25 show a blank 501 and an assembled document holding device 521 that has a plurality of partition panels, including front panels 4 and rear panels 5, having a trapezoidal shape. Each panel 4, 5 has a broader bottom edge defined by bottom fold line 7, and side edges 9 and 10 that taper to a narrower top edge defined by top fold line 6. Typically the transverse width along the top edge 6 is 50% or more of that along the bottom edge 7. The alternatively-shaped partition panels can be used with any of the brace embodiments described herein. The alternatively-shaped partition panels reduce the amount, and weight, of material to form a document holding device, without adversely affecting the document holding function, and add a unique aesthetic aspect to the device.

FIG. 1 also illustrates a plurality of openings 42 formed through the material of one or more of the panels 3 in the blank 1, illustrated as a pattern of diamond-shaped openings, as a means for reducing the weight of the document partition. The openings can be made in any shape, size, and arrangement, which preferably do not affect the structural integrity of the panels or the stability of the assembled document holding device, while reducing its overall weight.

Any one of the panels 3 can have a means for affixing a separated label to its planar surface, such as a name card or other information label. A pair of diagonal openings 41 is formed through the outer surface of the planar surface of a panel 3. The opposite corners of a rectangular paperboard card can be folded in and inserted into the openings 41 to retain the card.

In any of the embodiments and other aspects of the invention, the corrugation channels of a corrugated paperboard can be oriented in the elongated direction (in the top to bottom direction). This improves the structural integrity of the partition panels in a vertical orientation.

We claim:

1. A document holding device comprising at least one partition that includes a pair of partition panels joined contiguously at opposite end edges along hinged fold lines and arranged in a zigzag pattern, and a brace for fixing the position of the pair of partition panels in the arranged zigzag pattern.

2. The document holding device according to claim 1 wherein the at least one partition includes a plurality of partitions, and wherein the pair of partition panels consists of a front panel having a top edge and a rear panel having a top edge joined to the top edge of the front panel.

3. The document holding device according to claim 2 wherein each partition panel has a bottom edge, and a rear panel of a first partition is joined to a front panel of an adjacent partition along the respective bottom edges.

4. The document holding device according to claim 3 wherein the respective bottom edges are joined through an intermediate bottom spacer panel.

5. The document holding device according to claim 2, wherein the plurality of partitions includes three partitions, and further includes a first intermediate bottom spacer panel joining the rear panel of the first partition and the front panel of the second partition, and a second intermediate bottom spacer panel joining the rear panel of the second partition and the front panel of the third partition.

6. The document holding device according to claim 5, wherein the brace is an elongated member having opposed first and second ends, the first end being attached to a bottom of a first of the plurality of partition panels, and the second end being attached to a bottom of a second of the plurality of partition panels.

7. The document holding device according to claim 6, wherein the first end of the brace is integrally and hingedly attached to the bottom of the first partition panel, and the second end is attached to the second partition panel by insertion into a slot in the bottom of the second partition panel.

8. The document holding device according to claim 7, wherein the brace is a separated portion of the first partition panel.

9. The document holding device according to claim 7, wherein the brace includes a first brace, the first end of the first brace is hingedly attached to the first partition panel of the second partition, and the second end of the first brace is inserted into a slot in the bottom of the second partition panel of the first partition, and a second brace, the first end of the second brace is hingedly attached to the second partition panel of the second partition, and the second end of the second brace is inserted into a slot in the bottom of the first partition panel of the third partition.

10. The document holding device according to claim 9 wherein the shape of the plurality of partition panels is selected from the group consisting of rectangular and trapezoidal.

11. The document holding device according to claim 6, wherein the first end of the brace is attached to the first partition panel by insertion into a slot in the bottom of the first partition panel, and the second end of the brace is attached to the second partition panel by insertion into a slot in the bottom of the second partition panel.

12. The document holding device according to claim 11, wherein the brace is a separated portion of the first partition panel.

13. The document holding device according to claim 11, wherein the brace includes a first brace, the first end of the first brace is inserted into a slot in the bottom of the first partition panel of the second partition, and the second end of the first brace is inserted into a slot in the bottom of the second partition panel of the first partition, and a second brace, the first end of the second brace is inserted into a slot in the bottom of the second partition panel of the second partition, and the second end of the second brace is inserted into a slot in the bottom of the first partition panel of the third partition.

14. The document holding device according to claim 9 wherein the shape of the plurality of partition panels is selected from the group consisting of rectangular and trapezoidal.

15. The document holding device according to claim 1 wherein the material of the partition panels is selected from the group consisting of a corrugated paperboard, paperboard, corrugated plastic, plastic sheet, and composites and laminates thereof.

16. A blank of corrugated material for assembly into a document partition device according to claim 1, the blank including a plurality of partition panels joined contiguously at opposite end edges along hingable fold lines, and a brace for fixing the position of the plurality of partition panels in an assembled position.

17. The blank of claim 16 wherein plurality of partition panels comprises an alternating series of alternating series of at least one front panel having a first edge and one rear panel having a first edge joined to the top edge of the front panel.

18. The blank of claim 17 wherein the plurality of partition panels includes at least three front panels and three rear panels, and wherein the front panels have a second end and the rear panels have a second end, and the second end of one or more rear panels is joined to the second end of the adjacent front panel by a bottom spacer panel.

19. The blank of claim 18 wherein the brace comprises a separated portion of at least one of the plurality of partition panels.

20. The blank of claim 18 wherein the shape of the plurality of partition panels is selected from the group consisting of rectangular, trapezoidal, shapes having curved sides and a top edge, shapes having linear sides and a top edge, and combinations thereof.
